(19) United States
(12) Patent Application Publication
(10) Pub. No.: US 2011/0227640 A1
(43) Pub. Date: Sep. 22, 2011

(54) POWER SUPPLY DEVICE

(75) Inventor: YOICHI KYONO, Saitama (JP)

(73) Assignee: SANKEN ELECTRIC CO., LTD., Saitama-Ken (JP)

(21) Appl. No.: 13/048,937

(22) Filed: Mar. 16, 2011

(30) Foreign Application Priority Data
Mar. 19, 2010 (JP) 2010-063840

(51) Int. Cl. G05F 3/08; H02H 3/087

(52) U.S. Cl. 327/581; 361/82

(57) ABSTRACT

In a power supplying system that includes a plurality of power supply devices, each of which has a backflow prevention circuit at an output side thereof, and supplies power to a load device, a backflow prevention circuit is configured by using a hetero-junction FET (HEMT). A normally-on type GaNFET is used for the hetero-junction FET (HEMT), so that the backflow prevention circuit is further simplified.

### CROSS-REFERENCE TO RELATED APPLICATIONS

This application claims priority from Japanese Patent Application No. 2010-063840 filed on Mar. 19, 2010, the entire subject-matter of which is incorporated herein by reference.

### BACKGROUND OF THE INVENTION

1. Field of the Invention

The present invention relates to a power supply device, and more particularly, to a circuit technology of a backflow prevention circuit that is mounted when operating a plurality of power supply devices in parallel.

2. Description of the Related Art

In a load device for which high reliability is required, in order to normally operate the load device even when abnormality is caused in a power supply device, a plurality of power supply devices is redundantly operated in many cases. For example, by redundantly operating two power supply devices, each of which can supply power that a load device requires, the power is continuously supplied by one power supply device even when the other power supply device is stopped. Accordingly, the load device can continue to normally operate.

However, for a case where respective output terminals of the power supply devices are simply connected in parallel, when abnormality is caused in one power supply device, which is then shorted accordingly, current is enabled to flow from the normal power supply device to the abnormal power supply device and an output voltage is lowered due to over-current protection and the like, so that the load device is stopped. FIG. 1 shows a parallel connection example of power supply devices 1, 2 for solving the problem. While power is supplied to a load device 3 with the power supply devices 1, 2 being connected in parallel, when abnormality is caused in one power supply device and a voltage is thus lowered, current may be enabled to flow backward from the other normal power supply device to the abnormal power supply device. In order to prevent the backflow, a backflow prevention circuit consisting of diodes D1, D2 for backflow prevention is provided. This method is referred to as “OR ring.”

FIG. 2 shows another parallel connection example of the power supply devices 1, 2. When the diodes D1, D2 are inserted in high power lines, as shown in FIG. 1, a great loss is generated due to voltage droppings of the diodes D1, D2. Due to this, in the backflow prevention circuit of FIG. 2, the diodes D1, D2 are replaced with MOSFETs Q1, Q2 having less voltage dropping, so that conduction-loss is suppressed. In the method of FIG. 2, voltages between drains and sources of the MOSFETs Q1, Q2 are monitored. When the drains have potentials lower than those of the sources, a gate voltage is applied to the MOSFETs Q1, Q2 to turn on the MOSFETs Q1, Q2, thereby suppressing the voltage droppings in the MOSFETs Q1, Q2. When the drains have potentials higher than those of the sources, the MOSFETs Q1, Q2 are turned off to prevent the backflow of current to the power supply devices 1, 2. These operations are controlled by controllers 4, 5 of the MOSFETs for backflow prevention.

FIG. 3 shows still another parallel connection example of the power supply devices 1, 2. For a case where the power supply devices 1, 2 are operated with being connected to the load device, when a capacitor of high capacity and the like exist in the load device 3, high inrush current flows just after the MOSFETs Q1, Q2 are turned on. In addition, when the load device 3 is shorted, for example, over-current continues to flow in the MOSFETs Q1, Q2, so that the MOSFETs Q1, Q2 are damaged. In order to prevent this, in FIG. 3, MOSFETs Q3, Q4 for current limit, which are connected in a reverse direction to the MOSFETs Q1, Q2 for backflow prevention in FIG. 2, are added. In the method of FIG. 3, the currents and voltages of the MOSFETs Q3, Q4 are monitored, and gate voltages are linearly adjusted by controllers 6, 7 of the MOSFETs for power limit so that the MOSFETs Q1 to Q4 can operate in a safe operation area, thereby limiting the currents flowing in the MOSFETs Q1 to Q4.

In the meantime, JP-A-58-79474, JP-A-63-107460 and JP-A-2003-79069 disclose related-art backflow prevention circuits regarding the parallel operation of the power supply devices.

As described above, when the diodes D1, D2 of the OR ring circuit, which is a backflow prevention circuit, are replaced with the MOSFETs Q1, Q2, it is possible to reduce the loss of the backflow prevention circuit. However, in order to prevent the damage of the MOSFETs Q1, Q2 of the backflow prevention circuit when a power supply device starts up or when the load device 3 is abnormal, the MOSFETs Q3, Q4 that are connected in the reverse direction as shown in FIG. 3 should be added to the power supply devices, respectively. Accordingly, the power loss or mounting area is doubled.

In addition, in order to drive the MOSFETs Q1 to Q4 of the backflow prevention circuit, it is necessary to make a driving voltage of an output voltage or higher by a boosting circuit such as charge pump, which is not shown, so that the circuit is complicated. When a p-channel MOSFET is used, it is possible to solve the problem of the voltage for gate driving. However, since the p-channel MOSFET structurally has higher on-resistance than an n-channel MOSFET, the power loss is increased in the backflow prevention circuit.

### SUMMARY OF THE INVENTION

In order to solve the above-described problems, aspects of the invention configure a backflow prevention circuit having small power loss or mounting area and provide the backflow prevention circuit, a power supply device having mounted the backflow prevention circuit and a power supplying system configured by the power supply device.

According to a first aspect of the invention, there is provided a backflow prevention circuit that is used for a plurality of power supply devices supplying direct current voltages to a load device, wherein output terminals of the power supply devices are connected in parallel, wherein switch devices that block backflow of output currents of the respective power supply devices are provided between the respective output terminals of the power supply devices and power-receiving terminals of the load device, and wherein each of the switch devices consists of a hetero-junction FET.

According to a second aspect of the invention, in the backflow prevention circuit, wherein the hetero-junction FET has a threshold gate voltage that is a negative potential regarding a source potential.

According to a third aspect of the invention, the backflow prevention circuit further comprises voltage detecting means for detecting a both-end voltage of the hetero-junction FET, wherein when the voltage detection means detects that a voltage of the power-receiving terminal of the load device, to which one terminal of the hetero-junction FET is connected, is higher than a voltage of the output terminal of the power supply device, to which the other terminal of the hetero-junction FET is connected, the hetero-junction FET becomes off.

According to a fourth aspect of the invention, the backflow prevention circuit further comprises power loss detection means for detecting power loss, which is consumed in the hetero-junction FET, wherein the power loss is limited so that the power loss detected by the power loss detection means does not exceed a predetermined value.

According to a fifth aspect of the invention, there is provided a power supply device comprising the backflow prevention circuit as described above.

According to the invention, the hetero-junction FET (HEMT: High Electron Mobility Transistor) is used in the backflow prevention circuit. Thereby, it is possible to configure a backflow prevention circuit having small power loss or mounting area and to provide the backflow prevention circuit, a power supply device having mounted the backflow prevention circuit and a power supplying system configured by the power supply device.

In addition, a normally-on type GaNFET is used for the HEMT, so that it is possible to further simplify the control circuit.

### BRIEF DESCRIPTION OF THE DRAWINGS

FIG. 1 shows one example of a related-art power supplying system in which a backflow prevention circuit is configured by diodes;

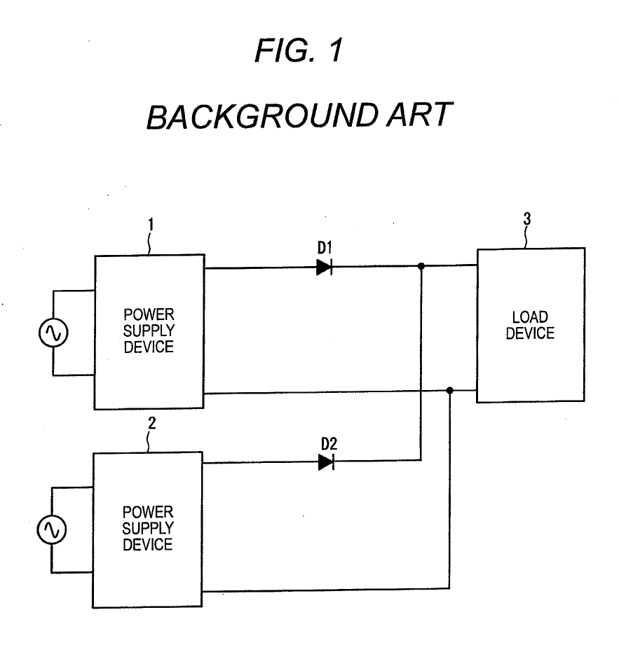

FIG. 2 shows another example of a related-art power supplying system in which a backflow prevention circuit is configured by MOSFETs;

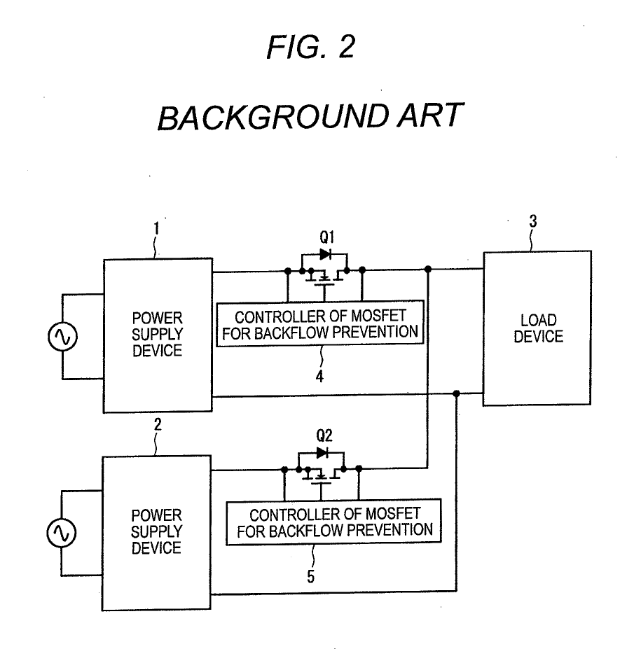

FIG. 3 shows still another example of a related-art power supplying system in which a backflow prevention circuit is configured by adding reverse MOSFETs to MOSFETs for an OR ring;

FIG. 4 shows an example of a power supplying system in which a backflow prevention circuit is configured by a normally-on type GaNFET according to an illustrative embodiment of the invention;

FIG. 5 shows an example of a configuration of a power limit controller of a backflow prevention circuit in a power supplying system in which the backflow prevention circuit is configured by a normally-on type GaNFET according to an illustrative embodiment of the invention; and

FIG. 6 shows an example of a configuration of a power limit controller of a backflow prevention circuit in a power supplying system in which the backflow prevention circuit is configured by a normally-off type GaNFET according to an illustrative embodiment of the invention.

### DETAILED DESCRIPTION OF THE PREFERRED EMBODIMENTS

Hereinafter, the illustrative embodiments of the invention will be described with reference to the drawings.

### First Illustrative Embodiment

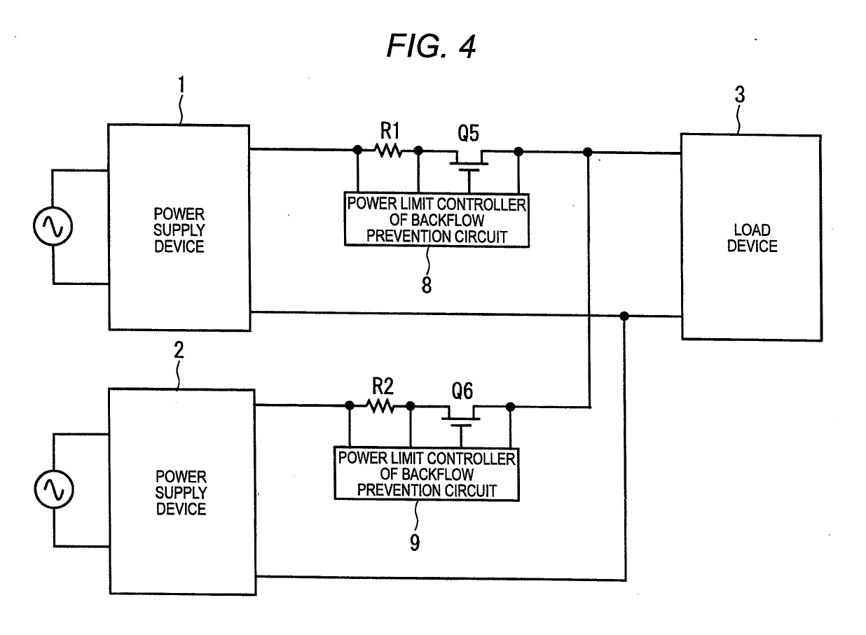

FIG. 4 shows a configuration of a power supplying system in which a normally-on type GaNFET, which is a HEMT, is used in a backflow prevention circuit.

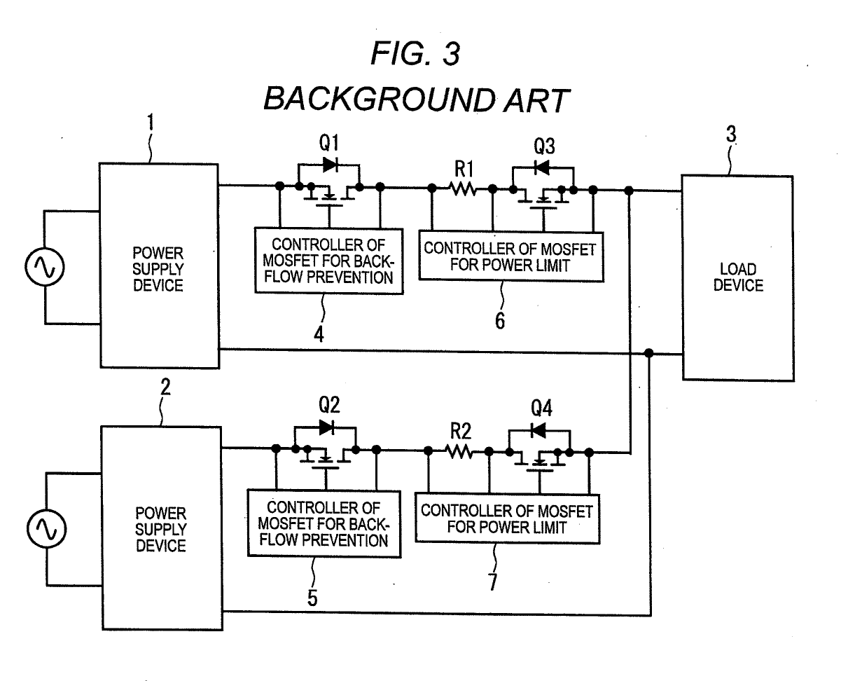

In the backflow prevention circuit of FIG. 4, the MOSFETs Q1, Q2 for backflow prevention and the MOSFETs Q3, Q4 for current limit of FIG. 3 are replaced with normally-on type MOSFETs Q5, Q6. Since a MOSFET structurally has a parasitic diode between a source and a drain, current is enabled to flow from the source to the drain even when a gate voltage is not applied. Accordingly, two MOSFETs that are connected in a reverse direction are required, as shown in FIG. 3. However, since a GaNFET does not have a parasitic diode, it is possible to limit bidirectional current by one device.

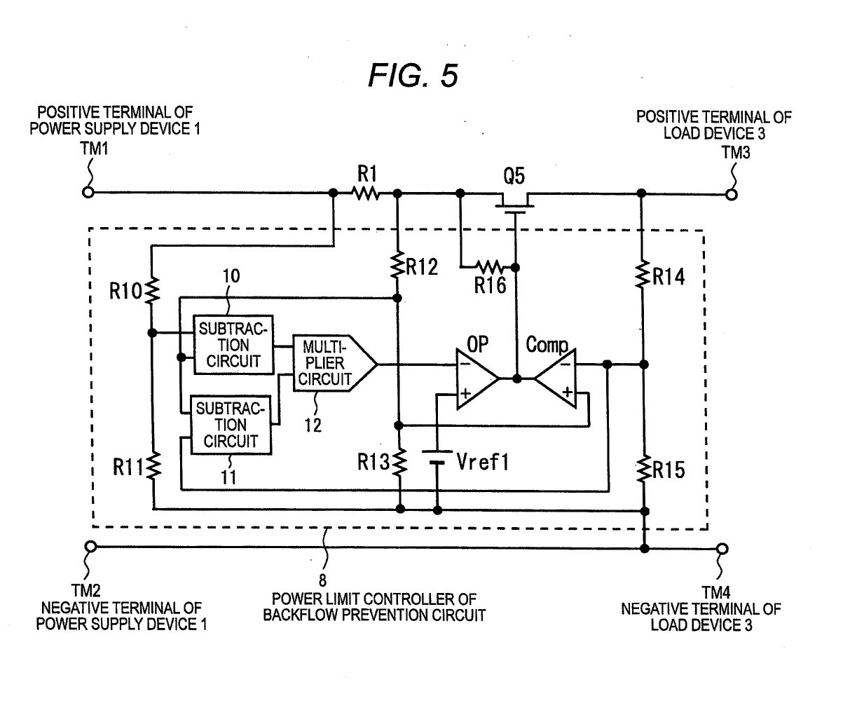

In addition, the GaNFET can change a threshold gate voltage by adjusting a process structure. Further, it is possible to separately make a normally-on type in which the threshold gate voltage is a negative potential and a normally-off type in which the threshold gate voltage is a positive potential (for example, refer to WO2003/071607). FIG. 5 shows a circuit of a power limit controller 8 of the backflow prevention circuit, which controls a gate signal of the GaNFET Q5 in the illustrative embodiment of FIG. 4. Since a power limit controller 9 of the backflow prevention circuit for the other power supply device 2 that is operated in parallel is the same as the power limit controller 8 of the backflow prevention circuit, the descriptions thereof will be omitted.

The power limit controller 8 of the backflow prevention circuit shown in FIG. 5 has resistances R10, R11 that divide a voltage (which corresponds to a power source voltage of the power supply device 1) of a connection point of a positive terminal TM1 of a power supply device 1 and a current detecting resistance R1 for a negative terminal TM2 of the power supply device 1, resistances R12, R13 that divide a voltage of a connection point of the current detecting resistance R1 and a GaNFET Q5 for the negative terminal TM2 of the power supply device 1 and resistances R14, R15 that divide a voltage (which corresponds to a power source voltage of a load device 3) of a connection point of the GaNFET Q5 and a positive terminal TM3 of the load device 3 for the negative terminal TM2 of the power supply device 1. In addition, the resistance values are set so that division ratios by the resistances are all the same.

A connection point of the resistances R12, R13 is connected to a non-inverting input terminal of a comparator Comp and a connection point of the resistances R14, R15 is connected to an inverting input terminal of the comparator Comp. A potential difference of the inverting and non-inverting input terminals of the comparator Comp is proportional to a voltage dropping of the GaNFET Q5. When the current flows from the power supply device 1 to the load device 3, a voltage of the non-inverting input terminal is higher than that of the inverting input terminal, so that an output of the comparator Comp becomes a high level. When the output of the comparator Comp is an open collector, a both-end voltage of the resistance R16 becomes 0V and a gate signal of the GaNFET Q5 becomes 0V. Since the GaNFET Q5 is a normally-on type, the GaNFET Q5 becomes an on-state. To the contrary, when the current flows backward from the load device 3 to the power supply device 1, the voltage of the inverting input terminal of the comparator Comp becomes higher. Thereby, the output of the comparator Comp becomes a low level and the gate signal of the GaNFET Q5 becomes a negative voltage. Accordingly, the GaNFET Q5 is off, so that the backflow of the current is prevented.

A connection point of the resistances R10, R11 and a connection point of the resistances R12, R13 are input to a subtraction circuit 10.

In addition, the connection point of the resistances R12, R13 and a connection point of the resistances R14, R15 are input to a substractor circuit 11. Thereby, voltages that are proportional to the voltage droppings of the resistance R15 and the GaNFET Q5 are output from the subtraction circuit 10 and the subtraction circuit 11. That is, the power limit controller 8 of the backflow prevention circuit detects the current, which flows in the GaNFET Q5, and the voltage, which is generated at both ends by using resistances R10, R11, R12, R13, R14 and R15 and subtraction circuit 10 and 11. Outputs of the subtraction circuit 10 and the subtraction circuit 11 are input to a multiplier circuit 12, and a voltage obtained by multiplying the voltages, i.e., a voltage proportional to the power loss of the GaNFET Q5 is output and input to an inverting input terminal of an operation amplifier OP. A reference voltage Vref1 is input to a non-inverting input terminal of the operational amplifier OP. When the output of the multiplier circuit reaches the reference voltage Vref1, the gate voltage of the GaNFET Q5 is pulled out to the negative side. In other words, the current is controlled so that the GaNFET Q5 operates in a safe operation area, thereby limiting the power loss.

In the first illustrative embodiment, the normally-on type GaNFETs Q5, Q6 are used. In a power supplying system in which a plurality of power supply devices is redundantly operated, during the normal operation, the power supply devices that are redundantly operated in parallel are operated in parallel to average the supplying power so that output currents of the respective power supply devices are same, thereby reducing the burden of the respective power supply devices to improve the reliability of the power supplying system, in many cases. Accordingly, in the power supply system that is operated as described above, the power supply devices that use the normally-off type GaNFET Q5, Q5 that become on during the normal operation are preferable because the GaNFET Q5, Q6 become on at a state in which the gate signal is not supplied. In addition, for a case where a normally-off type GaNFET is used like a second illustrative embodiment that will be described below, a power source that shifts the threshold is required. However, the normally-on type GaNFET does not require the corresponding power source. Accordingly, it is possible to simplify the configuration and to reduce the costs, compared to a case where a normally-off type GaNFET is used.

### Second Illustrative Embodiment

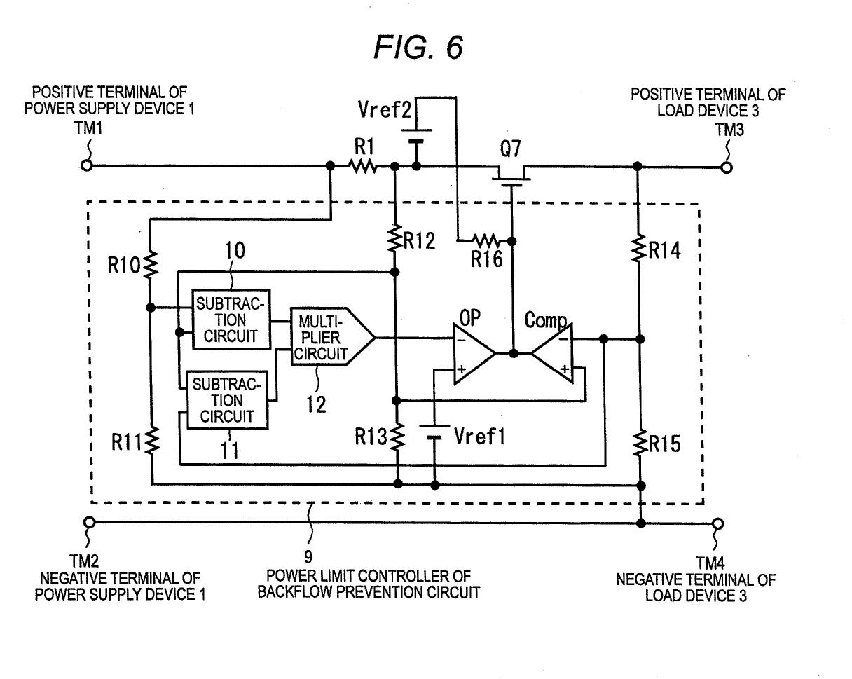

FIG. 6 is a circuit diagram showing a power limit controller 9 of the backflow prevention circuit that controls a gate signal of a normally-off type GaNFET Q7, when the normally-off type GaNFET Q7, which is a HEMT, is used in the backflow prevention circuit of the power supplying system of FIG. 4. Since a power limit controller of the backflow prevention circuit for the other power supply device that is operated in parallel is the same as the power limit controller 9 of the backflow prevention circuit, the descriptions thereof will be omitted.

In the power limit controller 9 of the backflow prevention circuit shown in FIG. 6, regarding the power limit controller 8 of the backflow prevention circuit of the first illustrative embodiment shown in FIG. 5, the normally-off type GaNFET Q7 is provided instead of the normally-on type GaNFET Q5, a reference power source Vref2 is further provided and a voltage of the reference power source Vref2 is applied to the resistance R16. The other configurations are the same as the power limit controller 8 of the backflow limiter circuit.

Describing a connection relation of the reference power source Vref2, the resistance R16 and the normally-off type GaNFET Q7, a negative terminal of the reference power source Vref2 is connected to a connection point of the resistance R16 and the normally-off type GaNFET Q7, a positive terminal of the reference power source Vref2 is connected to one terminal of the resistance R16 and the other terminal of the resistance R16 is connected to a gate terminal of the normally-off type GaNFET Q7. In the meantime, a both-end voltage of the resistance R16 is negligibly small, compared to the voltage of the reference power source Vref2. Accordingly, the negative terminal of the reference power source Vref2 may be connected to a connection point of the positive terminal TM1 of the power supply device 1 and the resistance R1. The reference power source Vref2 may be configured by a circuit such as charge pump and the like.

When the gate signal is 0V, the normally-off type GaNFET Q7 is at an off-state in which the current does not flow and the threshold voltage of the normally-off type GaNFET Q7 is shifted to a plus side. When the reference power source Vref2 is connected to the normally-off type GaNFET Q7 having the threshold value through the resistance R16, a gate voltage of the normally-off type GaNFET Q7 becomes a gate voltage that exceeds a threshold value enabling the desired current to flow when the comparator Comp is at a high level. In other words, the reference power source Vref2 is a bias power source that biases a gate signal so that the normally-off type GaNFET equivalently becomes a normally-on type GaNFET.

According to this illustrative embodiment, the normally-off type GaNFET is used in the backflow prevention circuit, so that it is possible to configure a backflow prevention circuit having small power loss or mounting area.

### Modified Embodiment

When the comparator Comp shown in FIGS. 5 and 6 is deleted, only the operational amplifier OP is used to supply the gate signal to the GaNFET and an absolute value of the output of the multiplier circuit 12 is output to the inverting input terminal of the operational amplifier OP, a current limiter circuit that operates the GaNFET in a safe operation area is made, rather than the backflow prevention circuit. In this case, the power supply device can cope with regenerative current, too.

As described above, the hetero-junction FET (HEMT) is used in the backflow prevention circuit, so that it is possible to configure the backflow prevention circuit, in which two MOSFETs have been conventionally required for one power supply device, with one HEMT. Thus, it is possible to remarkably reduce the power loss and the mounting area.

In addition, the normally-on type GaNFET is used for the HEMT, so that it is possible to further simplify the control circuit without sacrificing the on-resistance.

Although the invention has been described with reference to the illustrative embodiments, it should be noted that the illustrative embodiments are just exemplary and can be changed without departing from the scope of the invention. For example, in the above illustrative embodiments, the backflow prevention circuits are separately described from the power supply devices 1, 2. However, the backflow prevention circuits may be embedded in the power supply devices 1, 2. In addition, in the above illustrative embodiments, the GaNFET has been used in the backflow prevention circuit. However, since the parasitic diode is not formed in the HEMT, an FET having the HEMT structure, which is made of a material, rather than GaN, may be used. Further, in the above illustrative embodiments, the backflow prevention circuits are provided to the positive lines of the power supply devices. However, the backflow prevention circuits may be provided to the negative lines.

The invention can be widely used for a parallel operation of the power supply devices.

What is claimed is:

1. A backflow prevention circuit that is used for a plurality of power supply devices supplying direct current voltages to a load device,
wherein output terminals of the power supply devices are connected in parallel,
wherein switch devices that block backflow of output currents of the respective power supply devices are provided between the respective output terminals of the power supply devices and power-receiving terminals of the load device, and
wherein each of the switch devices consists of a hetero-junction FET.

2. The backflow prevention circuit according to claim 1,
wherein the hetero-junction FET has a threshold gate voltage that is a negative potential regarding a source potential.

3. The backflow prevention circuit according to claim 1, further comprising voltage detecting means for detecting a both-end voltage of the hetero-junction FET,
wherein when the voltage detection means detects that a voltage of the power-receiving terminal of the load device, to which one terminal of the hetero-junction FET is connected, is higher than a voltage of the output terminal of the power supply device, to which the other terminal of the hetero-junction FET is connected, the hetero-junction FET becomes off.

4. The backflow prevention circuit according to claim 1, further comprising power loss detection means for detecting power loss, which is consumed in the hetero-junction FET,
wherein the power loss is limited so that the power loss detected by the power loss detection means does not exceed a predetermined value.

5. A power supply device comprising a backflow prevention circuit that is used for a plurality of power supply devices supplying direct current voltages to a load device,
wherein output terminals of the power supply devices are connected in parallel,
wherein switch devices that block backflow of output currents of the respective power supply devices are provided between the respective output terminals of the power supply devices and power-receiving terminals of the load device, and
wherein each of the switch devices consists of a hetero-junction FET.
